(19) United States
(12) Patent Application Publication
(10) Pub. No.: US 2009/0039649 A1
(43) Pub. Date: Feb. 12, 2009

(54) Anti-leakage and Anti-Cracking Connection Hose

(76) Inventor: Huiliang Pan, Ningbo (CN)

Correspondence Address: HAOJIN WANG, 908 HEBRON DRIVE, ALLEN, TX, 75013, US

(21) Appl. No.: 11/852,515

(22) Filed: Sep. 10, 2007

(30) Foreign Application Priority Data
Aug. 8, 2007 (CN) 200720127717.8

(51) Int. Cl. F16L 19/08

(52) U.S. Cl. 285/382

(57) ABSTRACT

An anti-leakage and anti-cracking connection hose comprises a pipe section and a pipe joint at its end, wherein the pipe joint includes a nut, a nipple and a ferrule, and the end of the pipe section is wedged into a cavity between the nipple and the ferrule. The improvement comprises: one end of the ferrule extends into the nut and the end is provided with an annular recess recessed inwards in which the central portion of the bottom surface of the nut is embedded, the nipple passes through the nut and the ferrule; the ferrule, the pipe and the nipple are tightly combined together by punching the ferrule. The hose can prevent from water leakage because the nut is directly connected with the ferrule by means of the annular recess. Both the nipple and the ferrule bear the pulling force applied to the pipe and the pipe joint and the shearing force caused by the punching force, so that rupture of the nipple and cracking of the hose can be avoided.

### TECHNICAL FIELD

The present invention relates to a connection hose. More particularly, it relates to an anti-leakage and anti-cracking connection hose.

### BACKGROUND ART

Hoses are widely used for sanitary wares in kitchens and toilets, among others. The hose of this type possesses advantages in that its connection and fixing can be done in a simple and rapid way, and it is acceptable for both cold and hot water conditions.

A hose of the prior art is shown in FIGS. 1 and 2. Referring to FIGS. 1 and 2, the hose consists of a pipe section and two pipe joints at its two ends respectively (only one pipe joint is shown). The pipe section consists of an internal layer of inner pipe 4, a middle reinforcing thread 5, an outer layer of inner pipe 6 and an outer pipe 7 of woven thread, which are tightly combined together. The pipe joint includes a nut 1, a nipple 2 and a ferrule 3. The pipe section is set between the nipple 2 and the ferrule 3, and the pipe section is connected with the nut 1 by means of the nipple 2 after the ferrule 3 has been punched. The end of the ferrule 3 adjacent to the nut 1 is a straight end, and the ferrule 3 is not directly connected with the nut 1.

However, the above hose has following shortcomings: (1) since the ferrule is not directly connected with the nut, after the hose has been used for a period of time, water leakage may occur in a gap between the ferrule and the nut; (2) when the ferrule are punched, the punching force is almost applied on the nipple, so a very big shearing force is applied on the nipple and easily causes the nipple to be broken, then the shock action of water can cause the broken nipple to be brushed off the hose, therefore it results in cracking of the hose. The shortcomings not only shorten the service life of the hose, but also often bring to a user incommodity, even some damage to his belongings.

### DISCLOSURE OF THE INVENTION

It is therefore an object of the present invention to overcome the above shortcomings and to provide an anti-leakage and anti-cracking connection hose, which can avoid water leakage and cracking of the hose and increase its service life.

The present invention provides an anti-leakage and anti-cracking connection hose, which comprises a pipe section and a pipe joint at its end, wherein the pipe joint includes a nut, a nipple and a ferrule, and the end of the pipe section is wedged into a cavity between the nipple and the ferrule. The improvement comprises: one end of the ferrule extends into the nut and is provided with an annular recess recessed inwards in which the central portion of the bottom surface of the nut is embedded, the nipple passes through the nut and the ferrule; the ferrule, the pipe section and the nipple are tightly combined together by punching the ferrule.

With the connection hose configured as above, the central portion of the bottom surface of the nut is embedded into the annular recess at the end of the ferrule and then the nut is directly connected with the ferrule, so water leakage does not easily happen. Furthermore, both the nipple and the ferrule bear the pulling force applied to the pipe and the pipe joint owing to their connection and the shearing force caused by the punching force to the ferrule, it thus can avoid breakage of the nipple and cracking of the hose.

### BRIEF DESCRIPTION OF THE DRAWINGS

The present invention will be more specifically described below with reference to the attached drawings.

FIG. 1 is a sectional view of a hose in the prior art.

FIG. 2 is an enlarged view of the portion I in FIG. 1 depicting the pipe joint of the hose.

FIG. 3 is a sectional view of a connection hose according to an embodiment of the present invention.

FIG. 4 is an enlarged view of the portion II in FIG. 3 depicting the pipe joint of the connection hose according to an embodiment of the present invention.

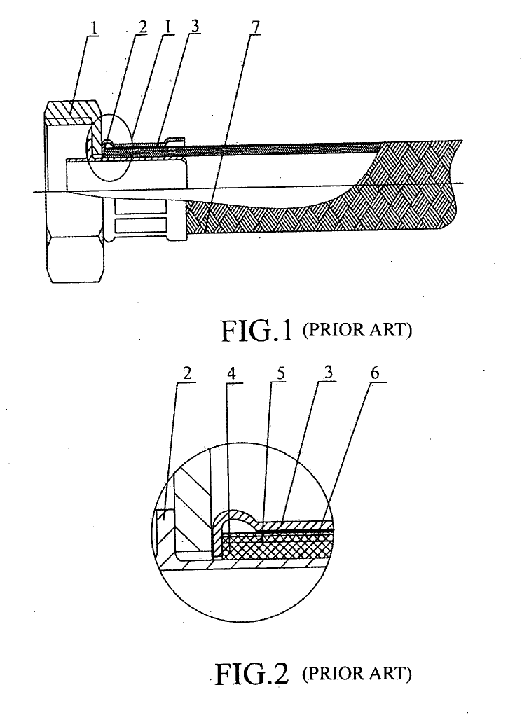

### BEST MODE FOR CARRYING OUT THE INVENTION

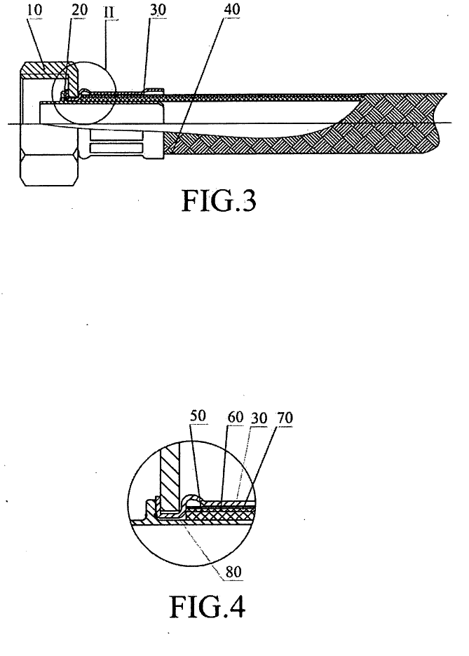

FIG. 3 is a sectional view showing one preferred embodiment of the connection hose according to the present invention. FIG. 4 is an enlarged view of the portion II in FIG. 3 depicting the pipe joint of the connection hose. Referring to FIGS. 3 and 4, the connection hose includes a pipe section and two pipe joints at its two ends, wherein each pipe joint includes a nut 10, a nipple 20 and a ferrule 30 and each end of the pipe section is wedged into the cavity between the nipple 20 and the ferrule 30. The improvement of the present invention comprises: one end of the ferrule 30 extends into the nut 10 and this end is provided with an annular recess 80 recessed inwards; the central portion of the bottom surface of the nut 10 is embedded within the recess 80, the nipple 20 passes through the nut 10 and the ferrule 30; the ferrule 30, the pipe section and the nipple 20 are thus tightly combined together by punching the ferrule 30. Therefore the ferrule 30 is directly connected with the nut 10 by means of the annular recess 80.

The connection hose according to the present invention also possesses at least some of the features indicated below:

Said pipe section consists of an internal layer of inner pipe 50, a middle reinforcing thread 60, an outer layer of inner pipe 70 and an outer pipe 40 of woven thread, which are tightly combined together.

Said nut 10 is a type of nut having internal thread. The nut can be a hexagon nut, a knurled nut or any type of nut. The standard of the nut is ¼″ compression(C), ⅜″ C, ⅜″, ½″ C, ½″, ¾″, or 1″ etc. The nut can be made of a forged brass H59, or steel formed by stretching.

Said nipple can be shaped by forging and turning or by form stretching. The material used for the nipple can be a forged brass H59, H62, H65 or H68, or stainless steel.

Said ferrule can be made of H65 or steel.

Said woven thread can be made of stainless steel thread 304 or 316, nylon wire, polyethylene silk, copper wire or any other wire of high strength.

The external diameter of said hose is in the range from 8 mm to 60 mm.

Said internal layer of inner pipe and said outer layer of inner pipe of the hose can be of polyvinyl chloride (PVC), polyethylene (PE), Ethylene-Propylene-Diene Monome (EPDM), SANTOPRENE®, or UNIPRENE® etc. Said middle reinforcing thread can be of terylene thread or cotton thread of high strength.

Said pipe section can have no middle reinforcing thread, but should increase its wall thickness.

The inventor has made creative improvement on the connection hose, therefore the advantages of the present invention are as follows:

(1) Water leakage owing to break of the nipple will not happen to the connection hose. The hose of this type possesses multiple protections, even if the nipple is broken because of its material or machining technology etc, the pipe will not disengage from the nut and thus water will not leak outwards, since the ferrule is directly connected with the nut.

(2) The connection hose will not crack owing to breakage of the nipple. The pulling force subjected to the ferrule of the pipe joint is twice or thrice as large as that subjected to the conventional hose, since only the nipple is subjected to the pulling force in the prior art, but both the nipple and the ferrule bear the force against their disengage from the pipe section according to the present invention.

According to the present invention, the anti-leakage and anti-cracking connection hose has performance parameters as follows:

nominal water pressure range≦1.6 Mpa;

applicable temperature range:
−10˜100° C. (EPDM inner pipe, PE inner pipe);
0˜85° C. (natural rubber inner pipe);
0˜80° C. (PVC inner pipe);
0-60° C. (inner pipe of other materials).

The connection hose according to the present invention is adequate for: (a) pipes for ice machines, (b) pipes for dishwashers, (c) connection pipes for faucets, (d) connection pipes for toilets, (e) pipes for water heaters, (f) pipes for washing machines, (g) pipes for shower baths.

It will be appreciated from the foregoing description that the present invention provides an anti-leakage and anti-cracking connection hose. Although the present invention has been described in relation to particular exemplary embodiments, it should be understood that the skilled in the art could put in practice with various modifications or variants without thereby departing from its scope.

1. A connection hose, comprising:
a pipe section; and
a pipe joint connected to an end of the pipe section, wherein the pipe joint includes a nut, a nipple and a ferrule, and the end of the pipe section being wedged into a cavity between the nipple and the ferrule, wherein
one end of the ferrule extends into the nut and is provided with an annular recess in which the central portion of the bottom surface of the nut is embedded;
the nipple passes through the nut and the ferrule;
the ferrule, the pipe section and the nipple are tightly combined together by punching the ferrule.

2. The connection hose according to claim 1, wherein said pipe section consists of an internal layer of an inner pipe, a middle reinforcing thread, an outer layer of the inner pipe and an outer pipe of woven thread which are tightly combined together.

3. The connection hose according to claim 2, wherein said internal layer of the inner pipe and said outer layer of the inner pipe are made of polyvinyl chloride, polyethylene, Ethylene-Propylene-Diene Monome, SANTOPRENE®, or UNIPRENE® and said middle reinforcing thread is terylene thread or cotton thread with high strength.

4. The connection hose according to claim 1, wherein said pipe section consists of an internal layer of an inner pipe, an outer layer of the inner pipe and an outer pipe of woven thread which are tightly combined together.

5. The connection hose according to claim 4, wherein said internal layer of the inner pipe and said outer layer of the inner pipe are made of polyvinyl chloride, polyethylene, Ethylene-Propylene-Diene Monome, SANTOPRENE®, or UNIPRENE®.

6. The connection hose according to claims 1, wherein said nut is a type of nut having internal thread.

7. The connection hose according to claim 6, wherein said nut is a hexagon nut or a knurled nut.

8. The connection hose according to claim 7, wherein standard of said nut is ¼″ compress (C), ⅜″C, ⅜″, ½″C, ½″, ¾″, or 1″.

9. The connection hose according to claim 6, wherein said nut is made of forged brass H59 or steel.

10. The connection hose according to claims 1, wherein an external diameter of said hose is in a range from 8 mm to 60 mm.
